(19) United States
(12) Patent Application Publication
(10) Pub. No.: US 2026/0225268 A1
(43) Pub. Date: Aug. 6, 2026

(54) SUPPLY LINE MANAGEMENT SYSTEM FOR A ROBOTIC PICKING STATION

(71) Applicant: Ocado Innovation Limited, Hatfield (GB)

(72) Inventors: Lily JUPP, London (GB); Herne HOLLAMBY, London (GB)

(21) Appl. No.: 19/576,262

(22) Filed: Mar. 24, 2026

Related U.S. Application Data
(63) Continuation of application No. PCT/EP2024/077309, filed on Sep. 27, 2024.

(30) Foreign Application Priority Data
Sep. 28, 2023 (GB) 2314909.9

(51) Int. Cl. B25J 19/00; B65G 1/04

(52) U.S. Cl. CPC B25J 19/0025; B65G 1/0478; B65G 1/0485

(57) ABSTRACT

The present disclosure relates to a robotic picking station for a storage system having a framework structure. The robotic picking station includes a robotic manipulator mountable on the framework structure, a supply line arranged to be routed through the framework structure to the robotic manipulator, the supply line being configured to provide a service to the robotic manipulator, and a supply line management system. The supply line management system includes a spool element defining a bending radius for the supply line about the robotic manipulator.

### RELATED APPLICATIONS

This application is a continuation of International Patent Application No. PCT/EP2024/077309 filed 27 Sep. 2024 and entitled “Supply Line Management System for a Robotic Picking Station,” which claims priority to United Kingdom Patent Application No. GB2314909.9 filed 28 Sep. 2023 and entitled “Supply Line Management System for a Robotic Picking Station”; the entire contents of all of which applications are incorporated herein by reference.

### TECHNICAL FIELD

The present disclosure relates generally to the field of robotic picking stations for use in warehouses or fulfilment centres. Aspects relate to an end effector for use on a robotic manipulator assigned to such a picking station, the robotic manipulator and picking station, and a grid-based storage and retrieval system comprising the picking station.

### BACKGROUND

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

PCT Publication No. WO2015/185628A (Ocado) describes a known storage and fulfilment system in which stacks of bins or containers are arranged within a framework structure. The bins or containers are accessed by load-handling devices operating on tracks located on the top of the frame structure. The load-handling devices are configured to lift bins or containers out from the stacks, and multiple load-handling devices can co-operating to access bins or containers located in the lowest positions of the stack. A system of this type is illustrated schematically in FIGS. 1 to 5 of the accompanying drawings.

FIG. 1 illustrates a framework structure 1 of a grid-based storage and retrieval system. The structure 1 comprises a number of upright members 3 supporting two sets of transversely arranged horizontal members 5, 7. The upright members 3 extend parallel to one another in the illustrated z-axis and stand orthogonally with respect to the horizontal members 5, 7. The first set of horizontal members 7 extend in the direction of the illustrated x-axis, while the second set of horizontal members 5 extend in the direction of the illustrated y-axis. The two sets of horizontal members 5, 7 form a grid pattern defining a plurality of grid cells. In the illustrated example, storage containers 9 are arranged in stacks 11, with each stack 11 being located beneath a respective grid cell.

FIG. 2 shows a large-scale plan view of a section of transverse track structure 13 forming part of the framework structure 1 illustrated in FIG. 1. The track structure 13 is located on top of the sets of horizontal members 5, 7. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the direction of the illustrated x-axis and a second set of tracks 19 which extend in the direction of the illustrated y-axis. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure 13 are also envisaged.

FIG. 3 shows a plurality of load-handling devices 31 moving on top of the framework structure 1 illustrated in FIG. 1. The load-handling devices 31, which may also be referred to as robots 31 or bots 31, are provided with sets of wheels to engage with corresponding x-or y-direction tracks 17, 19 to enable the bots 31 to travel across the track structure 13 and reach specific grid cells. The illustrated pairs of tracks 17, 19, separated by channels 21, 23, allow bots 31 to occupy or pass one another on neighbouring grid cells without colliding.

As illustrated in FIG. 4, a bot 31 comprises a body 33 on which are mounted one or more components which enable the bot 31 to perform its intended functions. These functions may include moving across the framework structure 1 on the track structure 13 and raising or lowering storage containers 9 (e.g. from or to stacks 11) so that the bot 31 can retrieve or deposit storage containers 9 in specific locations defined by the grid pattern. The bot 31 further comprises first and second sets of wheels 35, 37 which are mounted on the body 33 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19. The bot 31 also comprises container-lifting means, generally designated by 39, configured to raise and lower containers 9. The container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with corresponding features of the containers 9. For instance, the containers 9 may be provided with one or more apertures in their upper sides with which the engaging means can engage. Alternatively or additionally, the container engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the bot 31 has an upper portion 45 and a lower portion 47. The upper portion 45 is configured to house the one or more operation components (not shown) that enable the bot 31 to perform its intended functions, and the lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of framework structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the structure 1 (or an ingress point of the structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 or the second set of wheels 37 relative to the body 33, thereby enabling the load-handling device 31 to selectively move in either the first direction or the second direction across the tracks 17, 19 of the framework structure 1.

The wheel-positioning mechanism may include one or more linear actuators, rotary components or other means for raising and lowering at least one set of wheels 35, 37 relative to the body 33 to bring the at least one set of wheels 35, 37 out of and into contact with the tracks 17, 19. In some examples, only one set of wheels 35, 37 is configured to be raised and lowered, and the act of lowering the one set of wheels 35, 37 may effectively lift the other set of wheels 35, 37 clear of the corresponding tracks 17, 19, while the act of raising the one set of wheels 35, 37 may effectively lower the other set of wheels 35, 37 into contact with the corresponding tracks 17, 19. In other examples, both sets of wheels 35, 37 may be capable of being raised and lowered, advantageously meaning that the body 33 of the bot 31 stays substantially at the same height and therefore the weight of the body 33 and the components mounted thereon does not need to be lifted and lowered by the wheel-positioning mechanism.

As shown in FIG. 3, a plurality of identical load-handling devices 31 are provided, so that each load-handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers 9 transported to a port by a load-handling device 31 can be transferred to another location by the conveyor system, for example to a picking station (not shown). Similarly, containers 9 can be moved by the conveyor system to a port from an external location, for example to a container-filling station (not shown), and transported to a stack 12 by the load-handling devices 30 to replenish the stock in the system.

Each load-handling device 31 can lift and move one container 9 at a time. If it is necessary to retrieve a container 9 (“target container 9”) that is not located on the top of a stack, then the overlying containers 9 (“non-target containers 9”) must first be moved to allow access to the target container. This is achieved in an operation referred to hereafter as “digging”. During a digging operation, one of the load-handling devices 31 sequentially lifts each non-target container from the stack 11 containing the target container and places it in a vacant position within another stack 11. The target container can then be accessed by the load-handling device 31 and moved to a port for further transportation.

Each of the load-handling devices 31 is under the control of a central computer. Each individual container 9 in the system is tracked so that it can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a wide range of different items in the containers, while allowing reasonably economical access to all of the containers when required for picking.

With reference to FIG. 6, the system may further comprise a robotic picking station, generally designated by 50, mounted on top of the structure 1, alongside the load-handling devices 31 (not shown). The robotic picking station 50 comprises a robotic manipulator 52 comprising a robotic arm 54 and an end effector 56 for releasably engaging a product to be manipulated, together with several designated grid cells 60, 62. The robotic manipulator 52 is mounted on a plinth 58, which forms part of the framework structure 1. The plinth 58 is mounted above a single grid cell 60 and, depending on its location on the structure 1, can be surrounded by up to eight other grid cells 62. In general, the robotic manipulator 52 is configured to pick an item or product from any one of the containers located in one of the designated grid cells 62 and place it in a container located in another one of the cells 62. The load-handling devices 31 collect containers from, and deliver them to, the designated grid cells 62 as necessary. In this way, the robotic picking station 50 and the load-handling devices 31 work in conjunction to fulfil a customer order or redistribute products throughout the structure 1. The end effector 56 comprises a suction device 64 and an integrated vacuum generator, both of which form part of a suction assembly. The vacuum generator is supplied by a pressurised fluid, which is used to produce a vacuum or suction pressure for releasably engage an object or item with the suction device 64. A pressure line 66 is used to route the pressurised fluid along the robotic arm 54 from a pressure source, possibly located at ground level at the bottom of the framework structure 1, to the end effector 56 through the framework structure 1. Although not shown, the end effector 56 might include a parallel jaw gripper or the like for manipulating objects. The parallel jaw gripper may be in addition to or instead of the suction device 64. Moreover, the robotic manipulator 52 may also include one or more cameras to facilitate its control. Therefore, other power supply lines, such as hydraulic, pneumatic and/or electrical power supply lines, may be routed through the framework structure 1 to provide services to the robotic manipulator 52 as necessary. Multiple or single power supply lines (such the pressure line 66) may be gathered in trunking 68 for their protection and to ease their collective routing through the structure 1. Nevertheless, there exists a risk of rubbing between trunking and/or power supply line(s) and the framework structure 1 as the trunking and/or power supply line(s) are pulled and pushed through the framework structure 1 during movement of the robotic manipulator 52. This can lead to the generation of particulates and also result in the trunking and/or power supply line(s) catching on the framework structure 1, hindering movement of the robotic manipulator 52 and risking damage to the trunking and/or power supply line(s).

### SUMMARY

Accordingly, there is provided, in a first aspect, a robotic picking station for a storage system having a framework structure, the robotic picking station comprising: a robotic manipulator mountable on the framework structure; a supply line arranged to be routed through the framework structure to the robotic manipulator, the supply line being configured to provide a service to the robotic manipulator; and, a supply line management system configured to facilitate movement of the supply line as the robotic manipulator moves, the supply line management system comprising a spool element defining a bending radius for the supply line about the robotic manipulator, comparatively increasing the bending radius of the supply line about the robotic manipulator. A non-exclusive summary of optional and alternative features/elements is provided below; those features/elements may be utilized individually, in some embodiments, or may be combined together in various combinations, in other embodiments.

Optionally, the spool element comprises a cylindrical collar positioned around the base of the robotic manipulator.

Alternatively, the spool element comprises a cylindrical pedestal upon which the robotic manipulator is mounted. Optionally, the supply line management system further comprises a limiter for restricting vertical movement of the supply line on the pedestal.

Optionally, the supply line management system further comprises a first guide element mounted to the framework structure and positioned so as to hold the supply line clear of the framework.

Optionally, the first guide element is elongated so as to facilitate lateral movement of the supply line across the first guide element as the robotic manipulator moves.

Optionally, the first guide element comprises a curved surface and is oriented such that the curved surface defines a contact point between the first guide element and the supply line during its movement. The curved surface or arcuate profile reduces contact area between the supply line and the first guide element and the bending radius of the supply line about the first guide element.

Optionally, the first guide element is positioned such that the contact point is higher than an uppermost surface of the framework structure. This arrangement allows the supply line to lead into the robotic manipulator with a comparatively reduced bending.

Optionally, the curved surface is movable, reducing relative movement between the contact surface and the supply line.

Optionally, the first guide element comprises a cylindrical surface rotatable about its longitudinal axis.

Optionally, the supply line management system further comprises a second guide element mounted to the framework structure, the second guide element being positioned so as to hold the supply line clear of the framework structure.

Optionally, the second guide element is substantially perpendicular with respect to the first guide element.

Optionally, the second guide element is positioned lower on the framework structure with respect to the first guide element, easing retraction of the supply line through the framework structure.

Optionally, the second guide element extends underneath the first guide element, preventing gaps between the first and second guide elements into which the supply line might fall.

Optionally, the second guide element comprises a curved surface and is oriented such that the curved surface defines a contact point between the second guide element and the supply line during its movement.

Optionally, the curved surface of the second guide element is movable.

Optionally, the second guide element comprises a cylindrical surface rotatable about its longitudinal axis.

Optionally, the supply line management system further comprises a clamping arrangement for securing a section of the supply line to the framework structure.

Optionally, the clamping arrangement is positioned substantially opposite the second guide element.

In another aspect, there is provided a grid-based storage and retrieval system comprising the robotic picking station according to the first aspect.

### BRIEF DESCRIPTION OF THE DRAWINGS

These and other aspects will now be described, by way of example only, with reference to the accompanying drawing, in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load-handling device interacting with a container;

FIG. 6 shows a schematic depiction of a known robotic picking station for use on the automated storage and retrieval structure of FIG. 1;

FIG. 7 shows a schematic depiction of a robotic picking station in accordance with an embodiment;

FIGS. 8a to 8f are plan views of examples of supply line management systems for use in the robotic picking station of FIG. 7;

FIG. 9 shows a schematic depiction of a robotic picking station comprising another example of a supply line management system according to an embodiment; and,

FIG. 10 shows a schematic depiction of a robotic picking station comprising yet another example of a supply line management system in accordance with an embodiment.

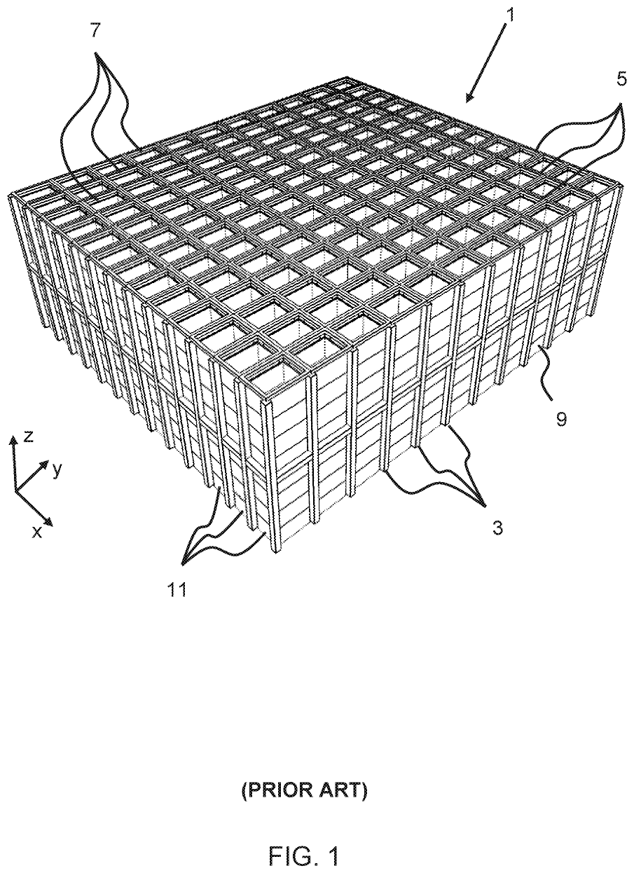

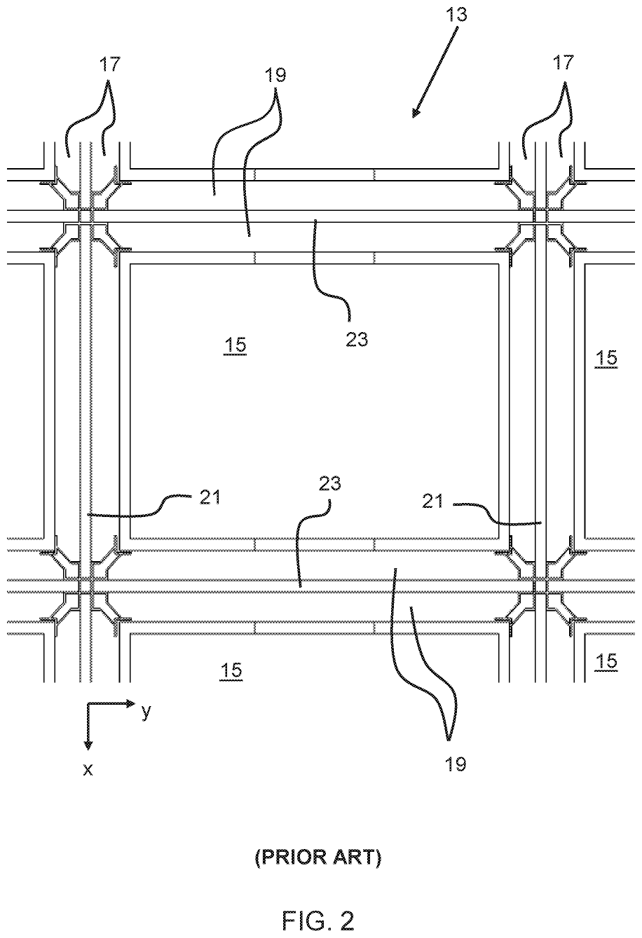

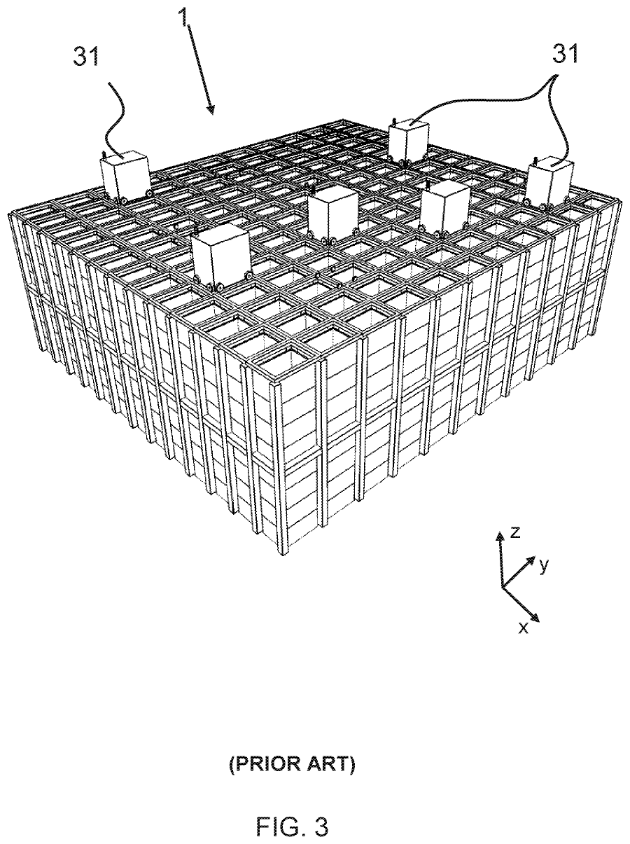

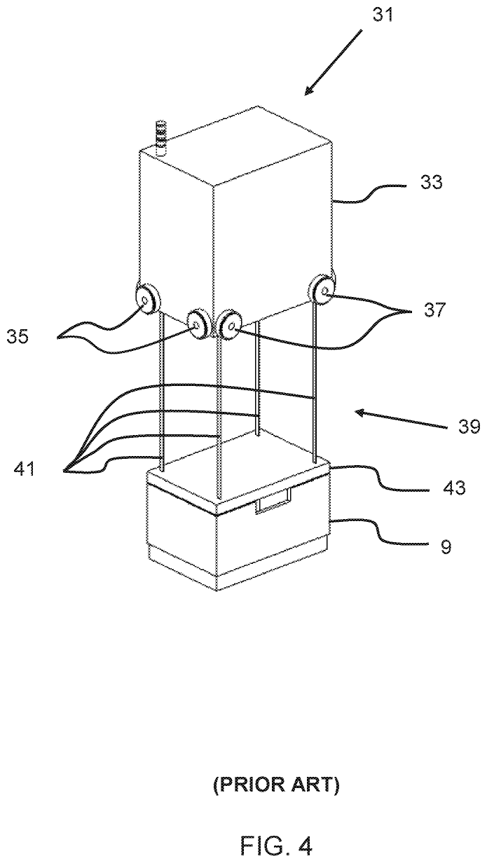

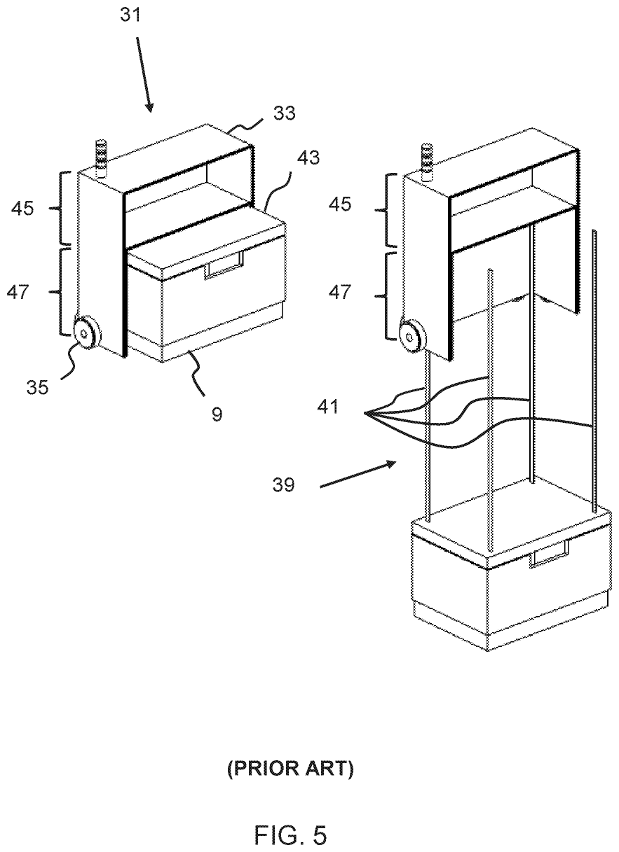

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the users forms “a”, “an”, and “the” include plural referents unless the content clearly dictates otherwise. It should also be noted that the term “or” is generally employed in its sense including “and/or” unless the content clearly dictates otherwise.

Moreover, for the purposes of this disclosure, the terms “trunking” and “power supply line” will hereinafter be collectively referred to a “supply line” and it will be understood that the term “supply line” can comprise a combination of trunking and one or more power supply lines, or just one or more power supply lines.

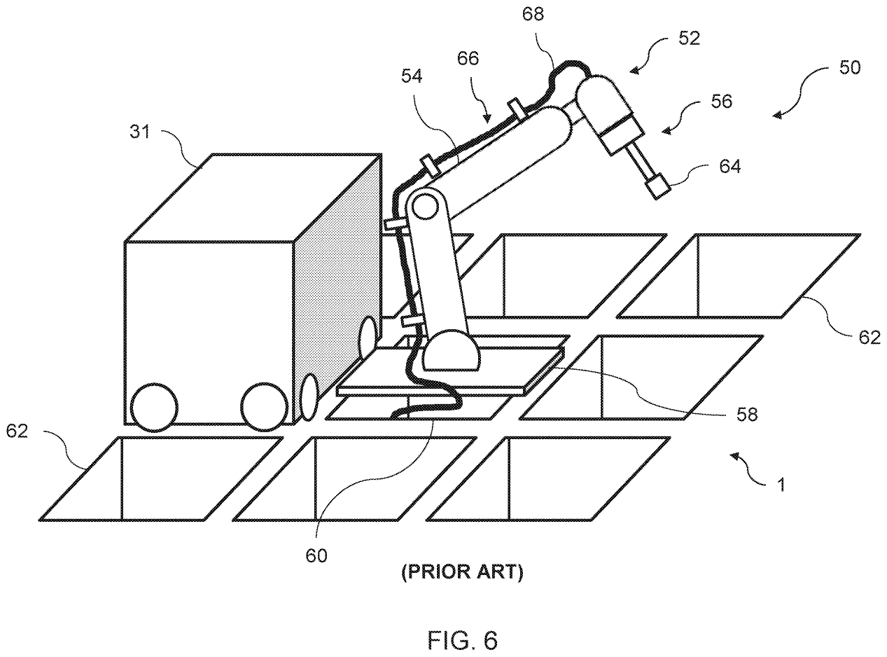

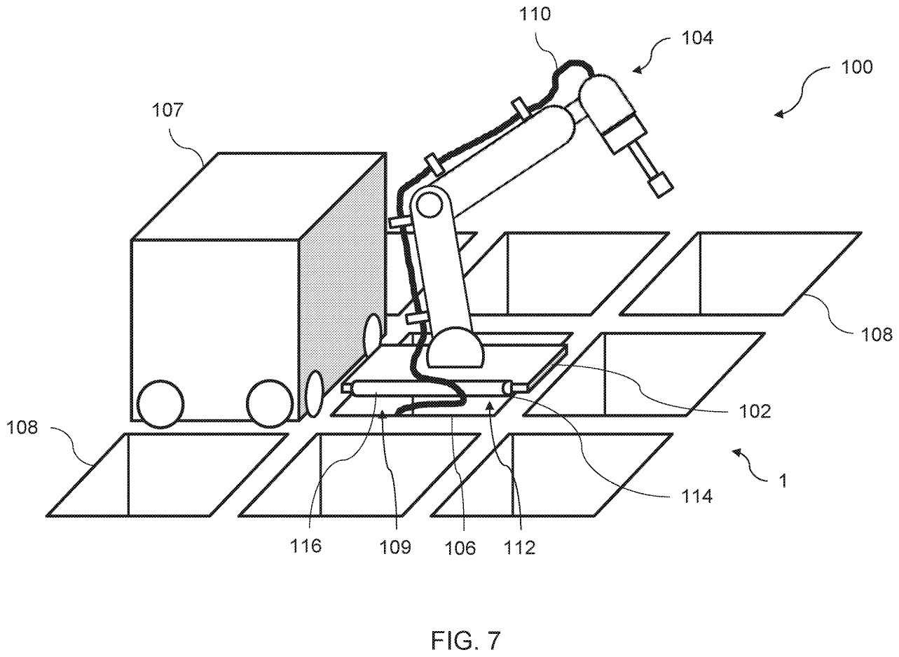

FIG. 7 shows a schematic depiction of a robotic picking station 100 according to an embodiment. The robotic picking station 100 is substantially the same as the one shown in FIG. 6. That is, is it mounted on a framework structure 1 similar to that previously described, and forms part of a grid-based storage and retrieval system. The framework structure 1 comprises a plinth 102 upon which a robotic manipulator 104 is mounted. The plinth 102 is of a size and shape such that it may be largely received within a space located above a single grid cell 106 whilst providing sufficient clearance to permit load-handling devices 107 to traverse adjacent grid cells 108. The framework structure 1 defines an opening 109 through which a supply line 110 is routed to provide a service (e.g. hydraulic, pneumatic and/or electrical power) to the robotic manipulator 104. The supply line 110 is mounted to the robotic manipulator 104 so that, as the robotic manipulator 104 moves, the supply line 110 is pulled and pushed through the opening 109. The robotic picking station 100 of this embodiment differs from the station 50 previously shown (in FIG. 6) in that it further comprises a supply line management system, generally designated 112. The overarching role of all of the embodiments of the supply line management system 112 disclosed herein is to facilitate movement of the supply line 112 through the framework structure 1 as the robotic manipulator 104. This is achieved by the supply line management system 112 holding the supply line 112 clear of the framework structure 1. By doing this, the interaction between the supply line 110 and framework structure 1 is reduced, when compared to the known setup, thus reducing any abrasion or rubbing of the supply line 110 as it moves relative to the framework structure 1 and lessening the possibility of the supply line 110 being snagged on the framework structure 1. In this embodiment, the supply line management system 112 comprises a guide element 114 mounted to the framework structure 1 to hold the supply line 110 clear of the framework structure 1. The guide element 114 is elongated so as to facilitate lateral movement of the supply line 110 along the length of guide element 114 as the robotic manipulator 104 moves. The guide element 114 comprises a curved surface 116 and is oriented such that the curved surface 116 defines a contact area between the guide element 114 and supply line 110 during its movement. The curved surface 116 provides an arcuate contact area, as opposed to an angled one, that functions to ease movement of the supply line 110 across and along the guide element 114, and also reduce the bending radius of the supply line 110 as it extends across the guide element 114 to the robotic manipulator 104. Preferably, the guide element 114 is positioned such that the contact area is higher than the uppermost surface of the framework structure 1 (in this case the upper surface of the plinth 102), meaning that the supply line 110 is supported above the uppermost surface of the framework structure 1, which allows the supply line 110 to lead into the robotic manipulator 104 with a comparatively reduced bending radius.

These and additional benefits are also realised in further examples of the supply line management system 112.

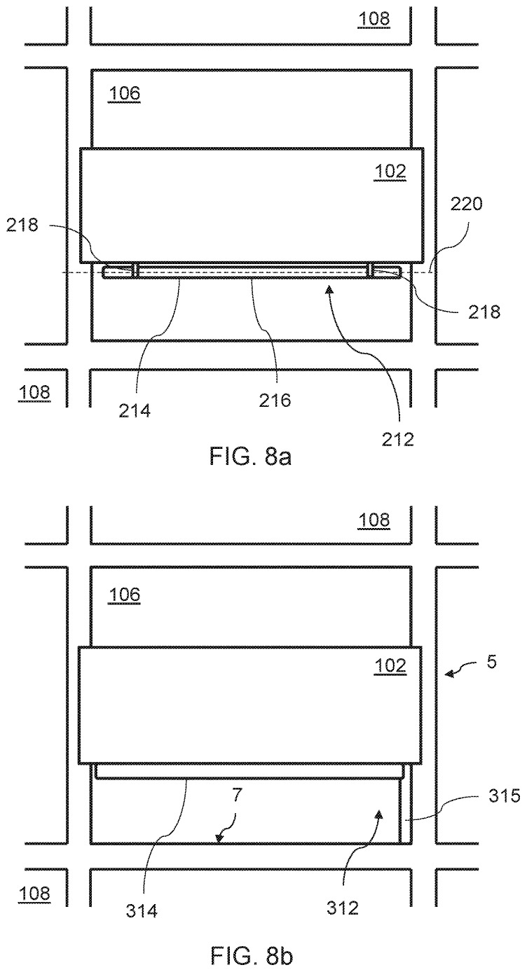

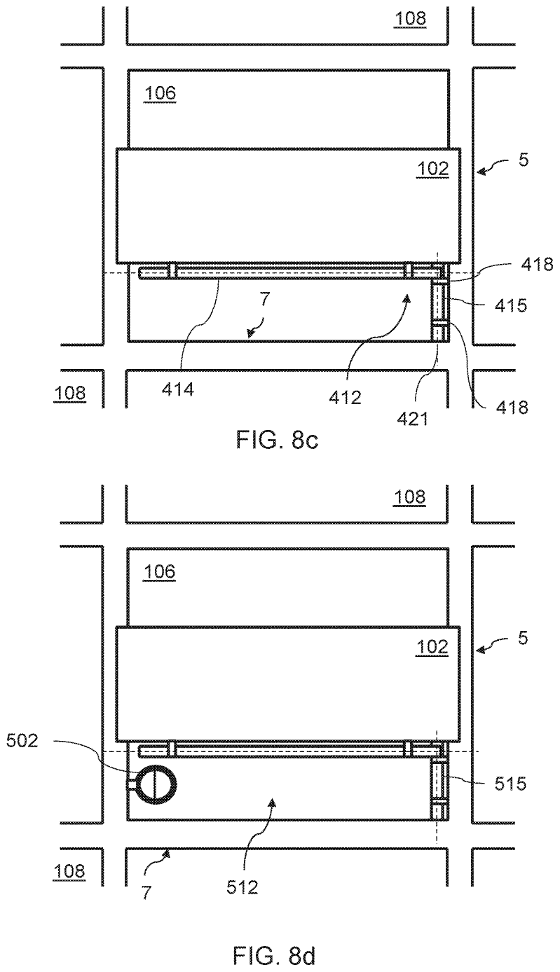

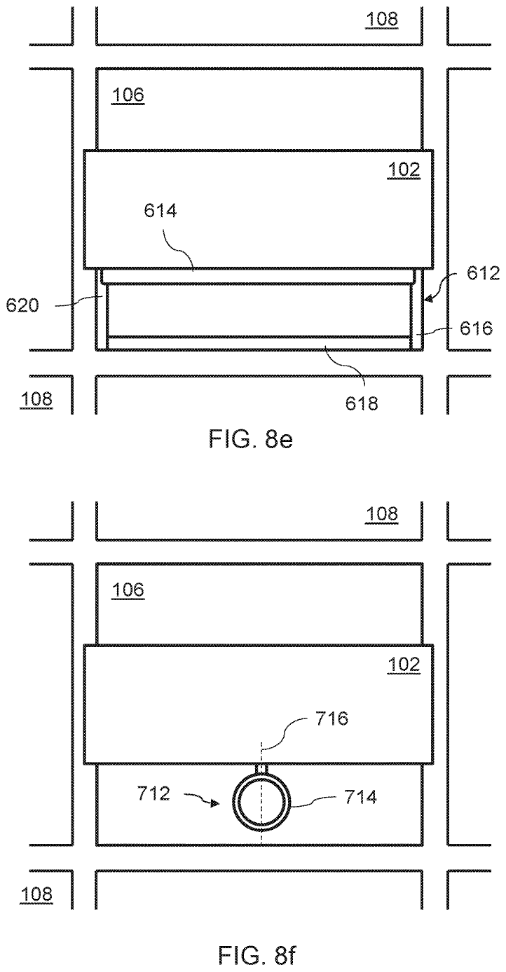

FIG. 8a shows an embodiment of the supply line management system 212 for use in the robotic picking station 100 of FIG. 7. The robotic manipulator 104 and other features of the robotic picking station 100, including the supply line 110, are not shown for clarity. This embodiment is characterised in that it includes an elongate guide element 214 comprising a curved surface 216 that is moveable. This arrangement reduces the relative movement between the contact area, defined by the moveable curved surface 216, and the supply line 110 as the supply line 110 is forced through the framework structure 1 by the movement of the robotic manipulator 104. Facilitating relative movement between the contact area of the curved surface 216 and supply line 110 reduces the friction generated therebetween and any associated damage to the supply line 110. In this embodiment, specifically, the curved surface 216 comprises a cylindrical surface and the guide element 214 is rotatably supported on the framework structure 1 (specifically the plinth 102) by brackets 218 such that it is rotatable about its longitudinal axis 220.

The supply line 110 might be naturally biased towards other parts of the framework structure 1 at least in part because of its routing through the framework structure 1, resulting in unwanted interactions between the supply line 110 and multiple parts of the framework structure 1. In order to prevent this, further embodiments might include a supply line management system comprising a second guide element mounted to the framework structure 1 and being positioned so as to hold the supply line 110 clear of the framework structure 1. One such embodiment is shown in FIG. 8b, which illustrates a supply line management system 312 comprising two guide elements 314, 315 secured to the framework structure 1. The first guide element 314 is the same as the one shown in and described with reference to FIG. 7, and is secured to the plinth 102, while the second guide element 315 is secured to one of the horizontal members 5, 7 of the framework structure 1, substantially perpendicular to the first guide element 314. As the plinth 102 is positioned relatively higher than or above the horizontal members 5, 7, the second guide element 315 is positioned lower on the framework structure 1 when compared with the first guide element 314. That is, the guide elements 314, 315 are vertically displaced with respect to each other. In this arrangement therefore the first guide element 314 provides a supporting role, holding the supply line 110 above the framework structure 1, while the second guide element 315 functions to ease the retraction of the supply line 110 as an excess length of the supply line 110 is unwound from the robotic manipulator 104 into the framework structure 1 during movement of the robotic manipulator 104. In order to prevent horizontal gaps between the guide elements 314, 315 into which the supply line 110 might be caught, one of the guide elements 314, 315 is arranged to overhang or extend across at least part of the other guide 314, 315. In this particular embodiment, the first guide element 314 projects over part of the second guide element 315, avoiding the possibility of the supply line 110 being caught between the guide elements 314, 315.

In other embodiments, such as the one shown in FIG. 8c, both the first and second guide elements 414, 415 of the supply line management system 412 are movable. In this embodiment, the first guide element 414 is substantially the same as the one shown in FIG. 8a and the second guide element 415 is also rotatably mounted to the framework structure 1 so as to reduce the relative movement between the supply line 110 and the contact area defined by the second guide element 415. Specifically, the second guide element 415 is mounted on one of the horizontal members 5, 7 of the framework structure 1 by brackets 420 such that it is rotatable about its longitudinal axis 421. Like the first guide element 414, the second guide element 415 is cylindrical, providing a continuously curved or arcuate contact surface for interacting or interfacing with the supply line 110. Although both the first and second guide elements 414, 415 are cylindrical in this and other embodiments, they could also be another shape so long as they provide a substantially curved contact surface for the supply line 110. As with the previous embodiment, the guide elements 414, 415 of this embodiment are vertically displaced with respect to each other. Accordingly, the first guide element 414 provides a supporting role, holding the supply line 110 above the framework structure 1, while the second guide element 415 functions to ease the retraction of the supply line 110 as an excess length of the supply line 110 is unwound from the robotic manipulator 104 into the framework structure 1 during movement of the robotic manipulator 104. In order to prevent horizontal gaps between the guide elements 414, 415 into which the supply line 110 might be caught, one of the guide elements 414, 415 is arranged to overhang or extend across at least part of the other guide 414, 415. In this particular embodiment, the first guide element 414 projects over part of the second guide element 415, avoiding the possibility of the supply line 110 being caught between the guide elements 414, 415.

In order to ensure that the supply line 110 is biased towards certain parts of the framework structure 1, any one of the previously described supply line management systems might further comprise a clamping arrangement for securing a section of the supply line 110 to the framework structure 1. In the embodiment shown in FIG. 8d, the clamping arrangement 502 is secured to or mounted on one of the horizontal members 5, 7 of the framework structure 1, although it is envisaged that the clamping arrangement 502 could be secured to other parts of the framework structure 1. The clamping arrangement 502 carries out two general functions. First, it serves to clamp a length of the supply line 110 so it remains substantially fixed relative to the framework structure 1, whilst ensuring that an excess length of the supply line 110 is provided to be taken up by and unwound from the robotic manipulator 104 as the robotic manipulator 104 moves. In this example, a section of the supply line 110 below the clamping arrangement 502 is substantially fixed in position, while an excess amount of the supply line 110 is provided above the clamping arrangement 502 to account for movement of the robotic manipulator 104. In this way, movement of the supply line 110 about the framework structure 1 is limited to a relatively short section, avoiding the need to move the whole supply line 110 through the framework structure and reducing the likelihood of stress-induced failures within the supply line 110. This arrangement also means that the robotic manipulator 104 is not required to pull all of the supply line 110 during its movements, but only the amount provided after the clamping arrangement 502, reducing the loading on the robotic manipulator 104. Second, it enables the supply line 110 to be held in a position in which it is predisposed towards a chosen section of the framework structure 1. In the given example, the clamping arrangement 502 is positioned opposite a second guide element 515 of the supply line management system 512. In this arrangement, the supply line 110 might be held by the clamping arrangement 502 such that it is inclined towards the second guide element 515, and the second guide element 515 functions to ease the retraction of the supply line 110 as the excess length of the supply line 110 is unwound from the robotic manipulator 104 into the framework structure 1 during movement of the robotic manipulator 104.

In other examples, the supply line management system 612 might comprise more than two guide elements 614, 616, 618, 620, providing full coverage of parts of the framework structure 1 that could otherwise interact with the supply line 110 as shown in FIG. 8e. Although the guide elements 614, 616, 618, 620 of this example are fixed, other embodiments are envisaged in which one or more, or all of the guide elements 614, 616, 618, 620 are rotatably mounted to the framework structure 1, providing all of the attendant advantages previously mentioned.

In further examples, the supply line management system 712 comprises a ring 714 through which the supply line 110 passes. The ring 714 is movably mounted to the framework structure 1 and rotatable about axis 716 so as to offer some compliance as the supply line 110 is pulled and pushed through it as the robotic manipulator 104 moves. The inner surface of the ring 714 is arcuate, providing a curved contact surface for the supply line 110. In this example, the ring 714 is mounted to the highest part of the framework structure 1 (i.e. the plinth 102), ensuring that the ring 714 functions to lift the supply line 110 above the framework structure 1 when it is fed into the robotic manipulator 104, in addition to its other function of guiding movement of the supply line 110 as the robotic manipulator 104 moves.

In other embodiments of the robotic picking station 100, the supply line management system further comprises a spool element defining a bending radius for the supply line about the robotic manipulator 104. In the absence of the spool element, the supply line 110 would wrap itself around the robotic manipulator 104 as the robotic manipulator 104 moves. The spool element functions to comparatively increase the bending radius of the supply line 110 when it is wrapped around the robotic manipulator 104, lessen the possibility of stress-induced failures within the supply line 110.

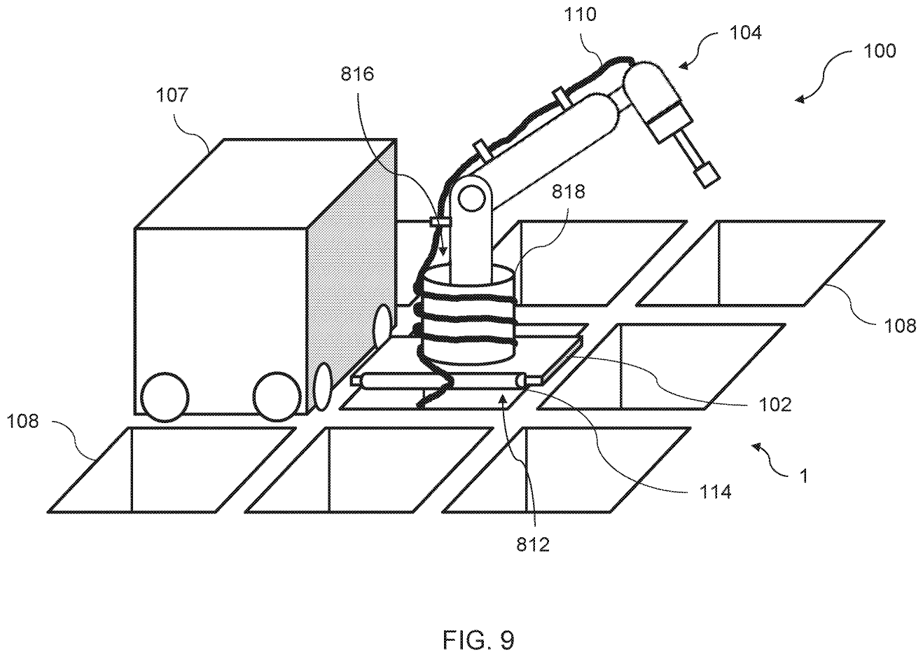

With reference to FIG. 9, in one embodiment, the spool element 816 of the supply line management system 812 comprises a cylindrical collar 818 positioned around the base of the robotic manipulator 104. The cylindrical collar 818 is sized to allow a full range of movement of the robotic manipulator 104, whilst comparatively increasing the bending radius of the supply line 110.

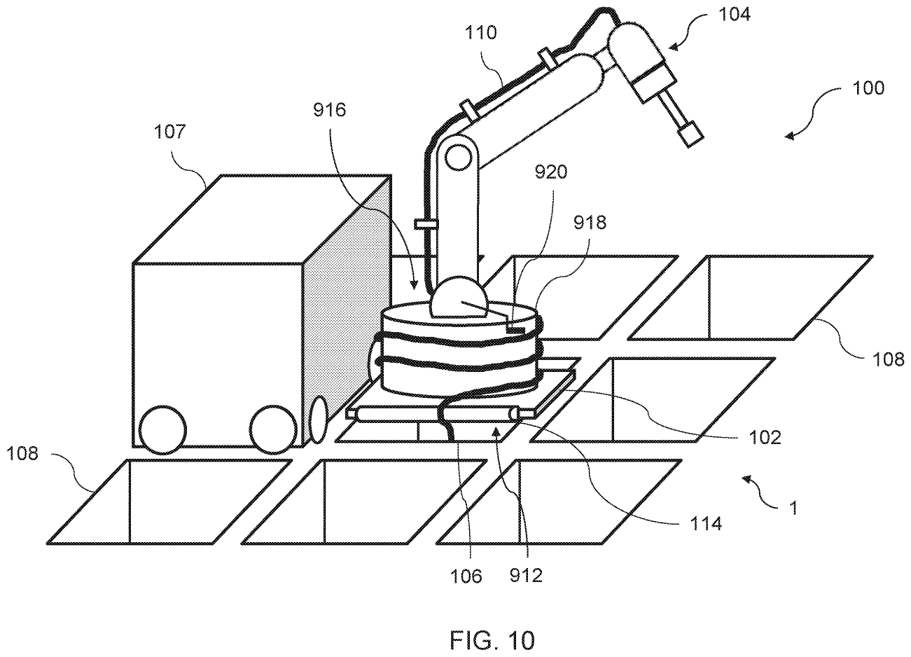

In a further embodiment, as shown in FIG. 10, the spool element 916 of the supply line management system 912 comprises a cylindrical pedestal 918 upon which the robotic manipulator 104 is mounted. Again, the pedestal 918 functions to comparatively increase the bending radius of the supply line 110, lessening the frequency of stress-induced failures within the supply line 110. In this arrangement, the supply line management system may further comprise a limiter 920 that restricts vertical movement of the supply line 110 on the pedestal 918, preventing it from being pulled over the pedestal 918 by the robotic manipulator 104.

Many embodiments of the robotic picking station 100 are shown, each having a supply line management system comprising different elements. It should be noted, however, that other embodiments are envisaged that may incorporate one or more elements from one or more of the different examples of the supply line management systems described herein. It should also be noted that, whilst the invention has been described within the context of a framework structure of a grid-based storage and retrieval system, the robotic picking stations may also be applied to other systems comprising a framework structure.

What is claimed is:

1. A robotic picking station for a storage system having a framework structure, the robotic picking station comprising:
a robotic manipulator mountable on the framework structure;
a supply line arranged to be routed through the framework structure to the robotic manipulator, the supply line being configured to provide a service to the robotic manipulator; and,
a supply line management system configured to facilitate movement of the supply line as the robotic manipulator moves, the supply line management system comprising a spool element defining a bending radius for the supply line about the robotic manipulator.

2. A robotic picking station according to claim 1, wherein the spool element comprises a cylindrical collar positioned around the base of the robotic manipulator.

3. A robotic picking station according to claim 1, wherein the spool element comprises a cylindrical pedestal upon which the robotic manipulator is mounted.

4. A robotic picking station according to claim 3, wherein the supply line management system further comprises a limiter for restricting vertical movement of the supply line on the pedestal.

5. A robotic picking station according to claim 1, wherein the supply line management system further comprises a first guide element mounted to the framework structure and positioned so as to hold the supply line clear of the framework structure.

6. A robotic picking station according to claim 5, wherein the first guide element is elongated so as to facilitate lateral movement of the supply line across the first guide element as the robotic manipulator moves.

7. A robotic picking station according to claim 5, wherein the first guide element comprises a curved surface and is oriented such that the curved surface defines a contact point between the first guide element and the supply line during its movement.

8. A robotic picking station according to claim 7, wherein the first guide element is positioned such that the contact point is higher than an uppermost surface of the framework structure.

9. A robotic picking station according to claim 7, wherein the curved surface is movable.

10. A robotic picking station according to claim 9, wherein the first guide element comprises a cylindrical surface rotatable about its longitudinal axis.

11. A robotic picking station according to claim 1, wherein the supply line management system further comprises a second guide element mounted to the framework structure, the second guide element being positioned so as to hold the supply line clear of the framework structure.

12. A robotic picking station according to claim 11, wherein the second guide element is substantially perpendicular with respect to the first guide element.

13. A robotic picking station according to claim 11, wherein the second guide element is positioned lower on the framework structure with respect to the first guide element.

14. A robotic picking station according to claim 13, wherein the second guide element extends underneath the first guide element.

15. A robotic picking station according to claim 11, wherein the second guide element comprises a curved surface and is oriented such that the curved surface defines a contact point between the second guide element and the supply line during its movement.

16. A robotic picking station according to claim 15, wherein the curved surface of the second guide element is movable.

17. A robotic picking station according to claim 16, wherein the second guide element comprises a cylindrical surface rotatable about its longitudinal axis.

18. A robotic picking station according to claim 1, wherein the supply line management system further comprises a clamping arrangement for securing a section of the supply line to the framework structure.

19. A grid-based storage and retrieval system comprising the robotic picking station according to claim 1.
